(19) United States
(12) Patent Application Publication
(10) Pub. No.: US 2010/0060787 A1
(43) Pub. Date: Mar. 11, 2010

(54) Digital Television Receiver and Information Processing Apparatus

(75) Inventor: Hiromasa Watanabe, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/413,098

(22) Filed: Mar. 27, 2009

(30) Foreign Application Priority Data
Sep. 5, 2008 (JP) 2008-228945

(51) Int. Cl. H04N 5/44; H04N 5/50

(52) U.S. Cl. 348/553; 348/731; 348/E05.097; 348/E05.096

(57) ABSTRACT

A digital television receiver including: a tuner configured to receive a broadcast signal; a video processor configured to decode video data contained in the broadcast signal and output video signal for displaying the video data; a communication module configured to establish a connection through a network to a first server providing first content data in a first format and a second server providing second content data in a second format; an image processing module configured to generate a first link image for connecting to the first server by the communication module and a second link image for connecting to the second server by the communication module; and a controller configured to control the video processor to output the video signal for displaying the first link image and the second link image.

### CROSS REFERENCE TO RELATED APPLICATION(S)

The present disclosure relates to the subject matters contained in Japanese Patent Application No. 2008-228945 filed on Sep. 5, 2008, which are incorporated herein by reference in its entirety.

### FIELD

The present invention relates to a digital television receiver and an information processing apparatus.

### BACKGROUND

Recently, digital television receivers for home use which receive digitized television broadcast signals transmitted via a broadcasting satellite, a communication satellite, or the like become widely used. These digital television receivers can receive a radio wave in which a video (motion picture), audio, data, and the like are multiplexed, and display the data on a screen in accordance with an input operation.

For example, data broadcast services have already been started in BS digital broadcast and digitized terrestrial broadcast in Japan. In these services, a broadcast station transmits data groups including character data, layout data, script programs, and the like which are described in BML format or the like, while superimposing the data groups on a broadcast radio wave. A digital television receiver receives and stores the broadcast radio wave, generates image, and displays the images on a screen.

Some digital television receivers in recent years have a network function for connecting to networks such as the Internet, and capable of utilizing HTML contents. As an example of such receivers, a publication JP-A-10-164545 discloses a CATV system in which a WWW server storing data such as program menus is provided in a central station, a terminal calls the data in the WWW server into the terminal by an operation via a WWW browser, so that a graphical menu display and applications are executed by using them. The term HTML (Hypertext Markup Language) means a description language for a Web page, and BML (Broadcast Markup Language) means a page description language for data broadcast on the basis of XML (eXtendable Markup Language).

In a conventional apparatus such as disclosed in the publication JP-A-10-164545, however, it is not considered to perform access to a server which deals with data in another description format under a condition where a browser screen in a predetermined description format is displayed.

In the case where the conventional apparatus is to access to a server which deals with data in BML format under a condition where an HTML browser is activated, for example, it is necessary to activate a BML browser after the HTML browser is once terminated. This lacks convenience.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram of the whole configuration of a digital television broadcast system including digital television receiver of an embodiment.

FIG. 2 is a block diagram showing an example of the configuration of the digital television receiver according to the embodiment.

FIG. 3 is a view showing an example of a menu image displayed by the digital television receiver according to the embodiment.

FIG. 4 is a view showing an example of a portal screen in the embodiment.

FIG. 5 is a diagram showing the configuration of a portal site server in the embodiment.

FIG. 6 is a diagram showing the flow of service provision from the portal site server in the embodiment.

FIG. 7 is a view showing applications included in the digital television receiver according to the embodiment, and numbers which uniquely correspond to the applications.

FIG. 8 is a diagram showing application designating information transmitted from the portal site server in the embodiment.

FIG. 9 is a flowchart showing the flow of processing of service processing information in the digital television receiver according to the embodiment.

### DETAILED DESCRIPTION OF THE EMBODIMENTS

Hereinafter, an embodiment of the invention will be described with reference to the drawings.

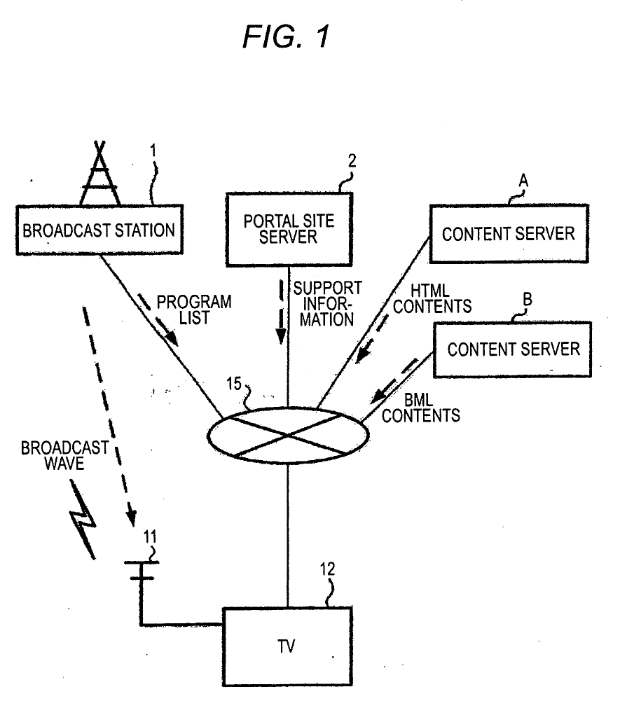

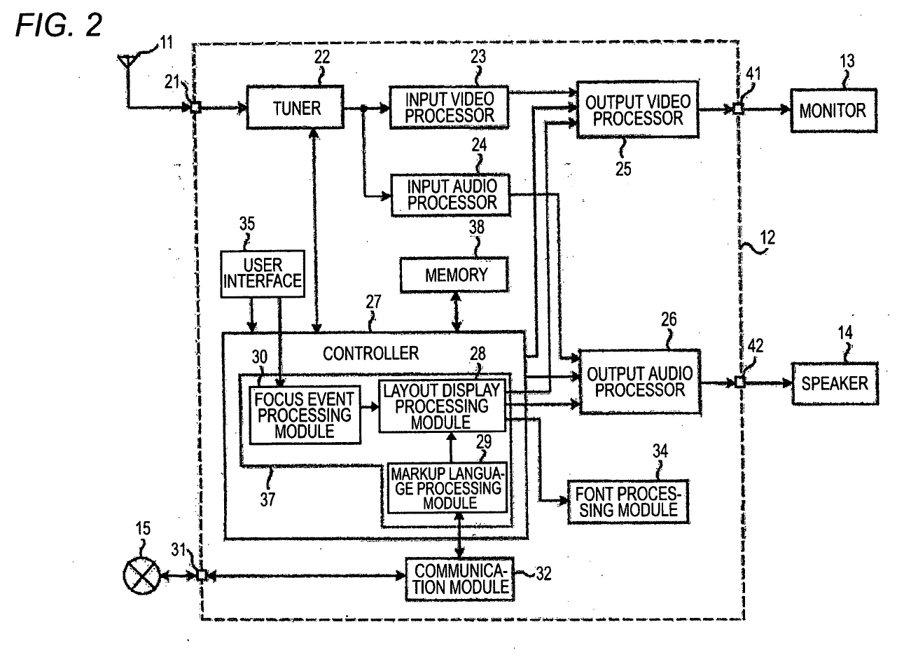

First, referring to FIGS. 1 and 2, a configuration of a digital television receiver (information processing apparatus) according to an embodiment of the invention will be described. FIG. 1 is a block diagram of a configuration of a digital television broadcast system including the digital television receiver according to the embodiment, and FIG. 2 is a block diagram showing an example of the configuration of the digital television receiver according to the embodiment.

Referring to FIG. 1, the digital television broadcast system is configured by: a broadcast station 1 which transmits a digital television broadcast wave; a digital television receiver 12 which receives the broadcast wave from the broadcast station 1 and has a function of accessing a desired server via network communication; a portal site server 2 which provides support information for individual apparatuses connected to a network 15 or support information of respective manufacturers; a content server A which provides content data in HTML format; and a content server B which provides content data in BML format. The network 15 is, for example, a LAN (Local Area Network). The support information is, for example, information provided from the manufacturer of the digital television receiver 12, and the like, and includes maintenance information of the apparatus, and information related to the apparatus such as functional information.

The portal site server 2 and the content servers A, B are mutually connected via the network 15, or they are directly and mutually connected via a network line (not shown). Although the example in which the content data in HTML format and in BML format are handled is described, the content data are not limited to those. Content data in other description formats can be handled.

The digital television receiver 12 of the embodiment has a function of acquiring an electronic program guide transmitted from a broadcast station and referring to them, a browser function of browsing service information provided by a predetermined server to be accessed, and other functions.

Next, with reference to FIG. 2, the configuration of the digital television receiver 12 of the embodiment will be described. In the digital television receiver 12, as shown in FIG. 2, television broadcast signals received by an antenna 11 are supplied to a tuner 22 via an input terminal 21. The tuner 22 selects a television signal of a desired broadcast channel from the input television broadcast signals, and outputs the selected television signal to an input video processor 23 and an input audio processor 24.

The input video processor 23 performs decode processing on video components of the input television signal, restores video signals in the unit of field or frame, and outputs the video signals to an output video processor 25. The input audio processor 24 performs decode processing on audio components of the input television signal, restores audio signals, and outputs the audio signals to an output audio processor 26.

A controller 27 controls other components provided in the digital television receiver 12 to operate as will be described later. A user interface 35 is connected to the controller 27. The controller 27 receives operation information supplied from the user interface 25, and controls other components so as to reflect the operation command input by a user.

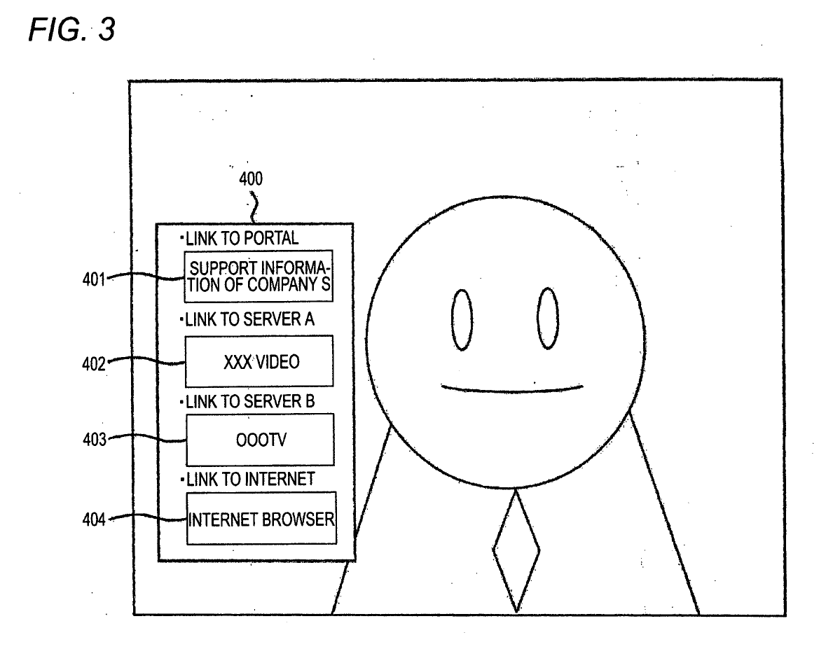

The controller 27 includes a browser processing module 37, activates application programs stored in a memory 38 such as menu image generating software, HTML software, BML software, image quality/audio parameter adjusting software, program list generating software, and program recording reservation software, thereby executing various kinds of processing, and displays a display screen on a monitor 13 via the output video processor 25. The menu image generating software is a program for generating a menu image for displaying link information and the like which will be described later with reference to FIG. 3. The HTML software is a program for processing data described in HTML format. The BML software is a program for processing data described in BML format. The image quality/audio parameter adjusting software is a program for adjusting an image quality parameter in the video signal, and an audio parameter in the audio signal. The program list generating software is a program for generating a program list image based on program list information received from the broadcast station 1. The program reservation software is a program for generating recording reservation information for the broadcast programs from the broadcast station 1.

The browser processing module 37 includes a layout display processing module 28, a markup language processing module 29, and a focus event processing module 30, decodes the content data described in the markup language, and reproduces the layout. The browser processing module 37 issues an access request to the network 15, and sends the access request to the network 15 via a communication module 32 and a connection terminal 31.

The content data obtained from the network 15 are supplied to the markup language processing module 29 via the connection terminal 31 and the communication module 32. The markup language processing module 29 analyzes the markup language of the input content data, and outputs the result to the layout display processing module 28.

The layout display processing module 28 generates bitmap information to be displayed based on the input analysis result, and outputs the bitmap information to the output video processor 25. The layout display processing module 28 generates a audio signal such as audio effect, and outputs the audio signal to the output audio processor 26. The layout display processing module 28 is connected to a font processing module 34, and, when a bitmap video signal is to be generated, calls the font processing module 34 to perform text rendering.

A user interface 35 which determines the operation information based on the key information input through an operating portion (not shown) including a remote controller 16 is connected to the focus event processing module 30. The focus event processing module 30 outputs the information related to a layout change in accordance with the operation information input from the user interface 35, to the layout display processing module 28. When information related to the layout change is output, for example, an image in which a predetermined icon is focused is displayed on the display screen which will be described later. As a result, the user can view the icon which is selected by the user.

The output video processor 25 converts the bitmap information supplied from the layout display processing module 28 into a video signal. The output video processor 25 selectively outputs the video signal supplied from the input video processor 23, and that obtained by converting the bitmap information (or a video signal which may be obtained by superimposing the video signals) to the monitor 13 via an output terminal 41, thereby displaying the video.

The output audio processor 26 selectively outputs the audio signal supplied from the input audio processor 24, and the audio signal supplied from the layout display processing module 28 (or a audio signal which may be obtained by superimposing the audio signals) to a speaker 14 via an output terminal 42, to reproduce the audio.

The memory 38 is configured by a read-only memory (not shown) which stores application programs to be executed by the controller 27, a write memory (not shown) which provides a work area for the controller 27, a non-volatile memory (not shown) which stores various setting information, control information, and other information, and the like.

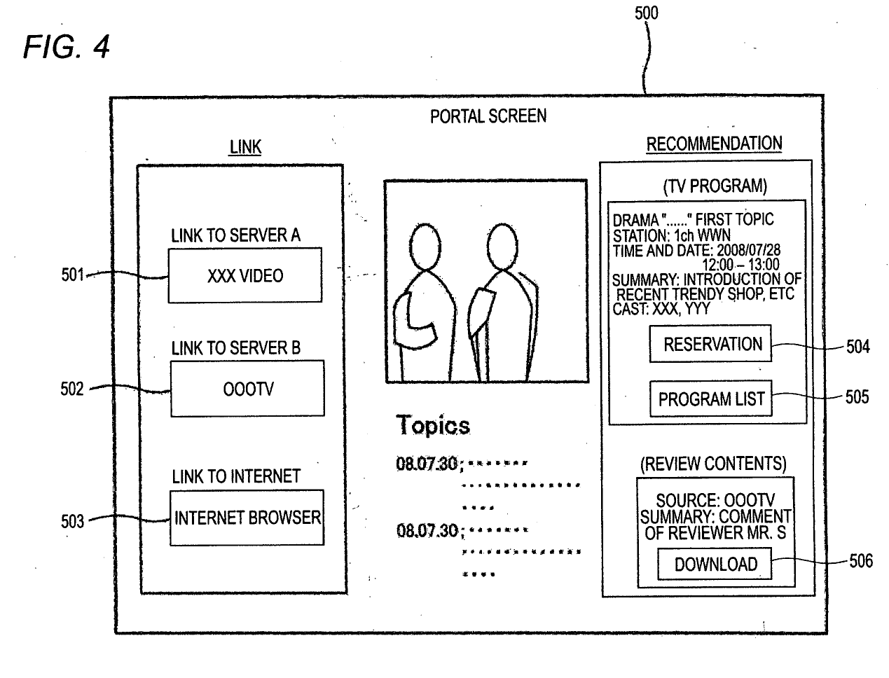

In the embodiment, the link information for connecting to the server A, the link information for connecting to the server B, and the like are displayed on the menu image or on the portal screen generated based on the information supplied from the portal site server 2. Hereinafter, the menu image and the portal screen in the embodiment will be described with reference to FIGS. 3 and 4.

FIG. 3 is a view showing an example of the menu image displayed by the digital television receiver 12 of the embodiment, and FIG. 4 is a view showing an example of the portal screen in the embodiment. The menu image 400 and the portal screen 500 in the embodiment are generated by data in, for example, HTML format or BML format. In the menu image 400 and the portal screen 500 in the embodiment, namely, the description format is different from the description format of the data handled by either one of the server A or the server B.

First, with reference to FIG. 3, the menu image 400 displayed by the digital television receiver 12 of the embodiment will be described. In the digital television receiver 12 of the embodiment, for example, the menu image 400 is displayed on the monitor screen in accordance with the operation input through the remote controller 16 or the like. Here, an example will be described in which the menu image 400 is displayed on the screen during the processing of the content data from a server or the audio-visual processing of the broadcast wave from the broadcast station 1.

On the menu screen 400, for example, various icons such as a link icon 401 for connecting to a portal site, a link icon 402 for connecting to the server A, a link icon 403 for connecting to the server B, and a link icon 404 for connecting to the Internet are displayed, and they can be selectively designated.

Although an example in which link information is displayed in the contents of the menu image is described, the menu image is not limited to this. Information for executing the operation function of the apparatus or the image quality/audio parameter adjusting function may be displayed.

Next, with reference to FIG. 4, the portal screen 500 displayed in the digital television receiver 12 of the embodiment will be described. On the portal screen 500 in the embodiment, for example, information related to various services including support information provided from the manufacturer of the digital television receiver 12, information of links to servers, and recommendation information for introducing recommendation contents delivered from the servers, broadcast stations, and the like is displayed.

Specifically, as shown in FIG. 4, various icons such as a link icon 501 for connecting to the server A, a link icon 502 for connecting to the server B, a link icon 503 for connecting to the Internet, a reservation icon 504 for performing the recording reservation of a broadcast program, a program list icon 505 for displaying a program list such as an EPG, and an icon 506 for downloading content data from servers connected via the network 15 are displayed on the portal screen 500 in the embodiment. Therefore, the user can select and designate various services to be provided.

In the embodiment, as described above, link information to a plurality of servers which are different in description format can be displayed on the same screen. Therefore, it is easy to access respective servers.

In the embodiment, furthermore, data in BML format can be processed under a condition where the screen in HTML format is displayed, and data in HTML format can be processed under a condition where the screen in BML format is displayed.

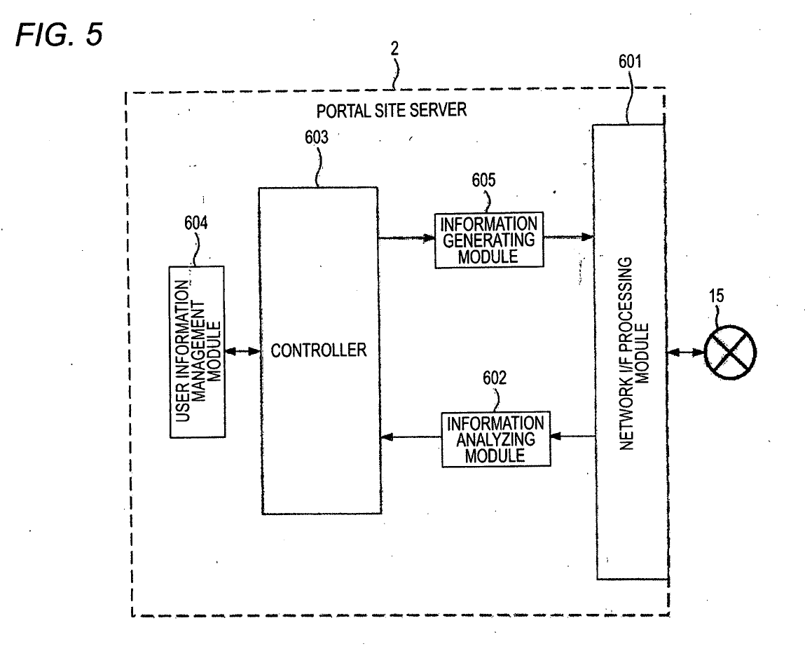

The portal site server 2 in the embodiment has a function of, when requests for various services are accepted as a result of the selection and designation of the icons 501 to 506, transmitting data related to the selected service and application designating information for designating an application program required for processing the data, to the digital television receiver 12. Hereinafter, the function will be described with reference to FIGS. 5 to 8.

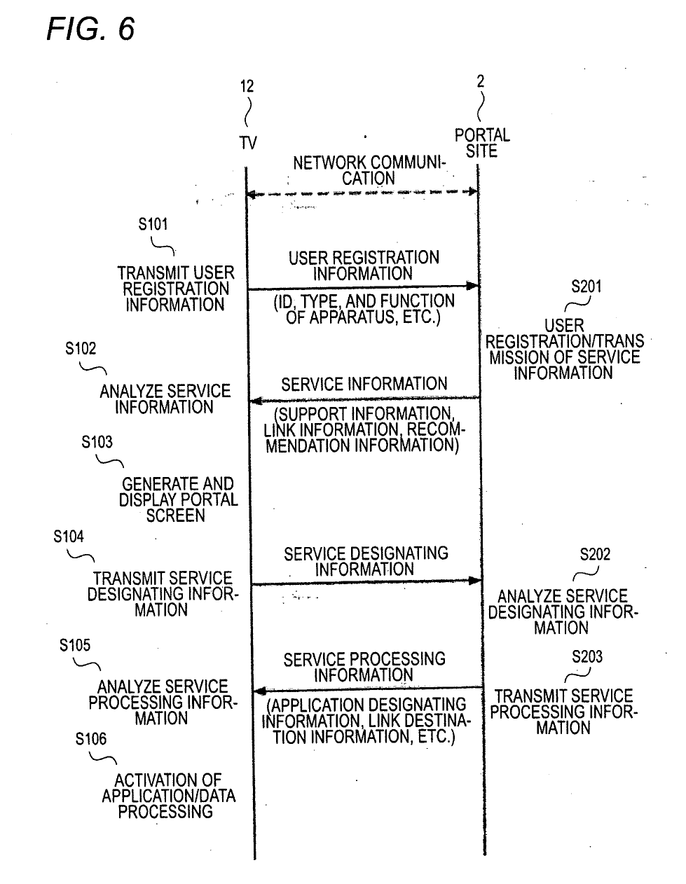

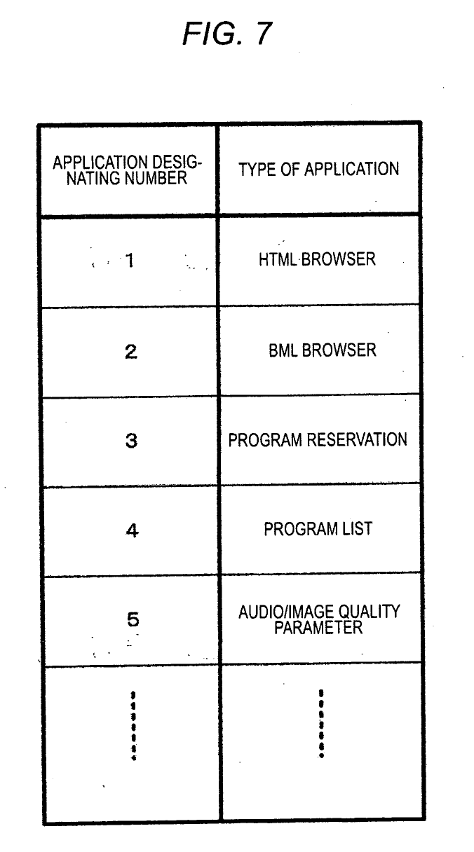

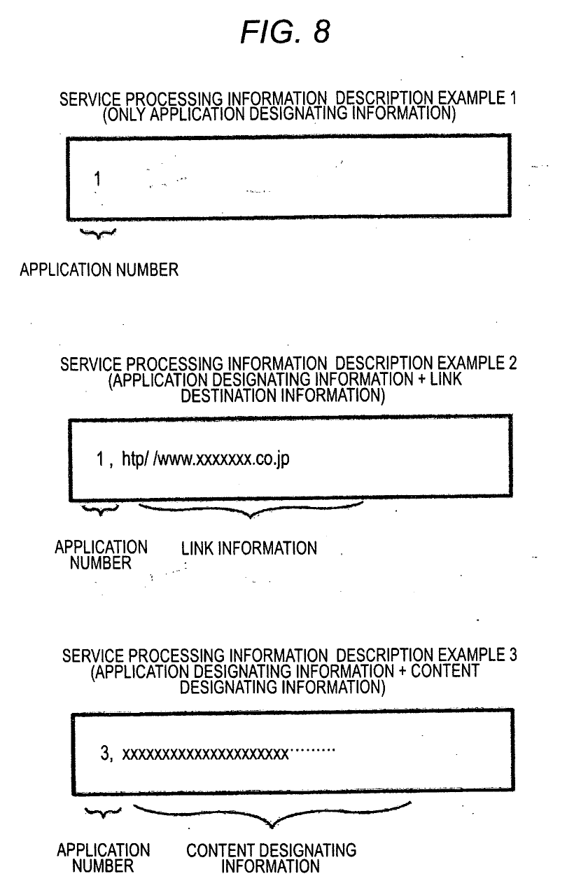

FIG. 5 is a diagram showing the configuration of the portal site server 2 in the embodiment. FIG. 6 is a diagram showing the flow of service provision from the portal site server 2 in the embodiment. FIG. 7 is a view showing the applications included in the digital television receiver 12 of the embodiment and the designation numbers which uniquely correspond to the applications. FIG. 8 is a diagram showing application designating information transmitted from the portal site server 2 in the embodiment.

First, with reference to FIG. 5, the configuration of the portal site server 2 in the embodiment will be described. For example, the portal site server 2 in the embodiment is configured by a network interface processing module 601, an information analyzing module 602, a controller 603, a user information management module 604, and an information generating module 605.

The network interface processing module 601 is a communication interface which performs communication with the digital television receiver 12 via the network 15. The network interface processing module 601 transmits the service information to the digital television receiver 12, receives service designating information from the digital television, and outputs the service designating information to the information analyzing module 602.

The information analyzing module 602 analyzes the information received from the network interface processing module 601, and outputs the analysis result to the controller 603.

The controller 603 controls the operation of the portal site server 2. The controller 603 performs processing in accordance with the information analyzed by the information analyzing module 602. In the controller 603 in the embodiment, when service designating information is received from the digital television receiver 12, for example, information related to the digital television receiver 12 is read out from the user information management module 604. The information of service to be transmitted, the information designating the application to be activated in the digital television receiver 12 for performing the service, and other information are determined, and then output to the information generating module 605.

The user information management module 604 stores and manages the ID information related to various apparatuses connected via the network 15, the information related to applications which can be executed respectively by these apparatuses, and other information. The information managed in the user information management module 604 is the user registration information to be transmitted to the portal site server 2 via the network 15 or the like. The user registration information will be described later with reference to FIG. 6.

In accordance with the instruction made by the controller 603, the information generating module 605 generates support information, link information to respective servers, application designating information, and the like which are to be transmitted to the apparatuses that communicate therewith via the network 15, and outputs the information to the network interface processing module 601.

As described above, the portal site server 2 in the embodiment provides various services to apparatuses which communicate therewith via the network 15, with reference to the user registration information. Hereinafter, the flow of providing the service in the portal site server 2 in the embodiment will be described with reference to FIG. 6.

As shown in FIG. 6, first, the digital television receiver 12 of the embodiment transmits the own registration information to the portal site server 2 connected via the network 15 (S101). The registration information includes information related to the apparatus ID, the type of the apparatus, the functions (applications) which can be performed by the digital television receiver 12, and the like.

When the registration information is received, the portal site server 2 performs the user registration of the digital television receiver 12, and transmits the information of the service to be provided (S201). The service information includes the support information from the manufacturer, link information to respective servers connected to the network 15, recommendation information, and other information.

Next, the digital television receiver 12 analyzes the received service information (S102), and generates and displays the portal screen 500 shown in FIG. 4 on the monitor 13 (S103). When a predetermined service is selected by the designation of an icon on the portal screen 500, for example, the service designating information for requesting the provision of the service is transmitted to the portal site server 2 (S104).

When the service designating information is received, the portal site server 2 analyzes the service designating information (S202), and determines the application to be activated in the digital television receiver 12 with reference to the registration information. Then, the portal site server 2 transmits the service processing information including the application designating information for designating the determined application, to the digital television receiver 12 (S203).

The service processing information includes as required, in addition to the application designating information, the information related to various services such as the information indicating the link of the server. The service processing information will be described later with reference to FIG. 8.

Finally, the digital television receiver 12 analyzes the received service processing information (S105). Then, the designated application is activated, and the data processing by the application is executed (S106).

Next, the service processing information output from the portal site server 2 in the embodiment will be described with reference to FIGS. 7 and 8.

First, the application designating information in the embodiment will be described with reference to FIG. 7. As described above, the service processing information in the embodiment includes the application designating information. In the embodiment, meta-information utilizing numeric characters is dealt as the application designating information.

The user information transmitted to the portal site server 2 from the digital television receiver 12 includes the information for designating symbols such as numeric characters or letters which uniquely correspond to applications which can be executed by the receiver. Accordingly, the portal site server 2 recognizes the number corresponding to the predetermined application with reference to the stored user registration information, so that the number can be transmitted to the digital television receiver 12 as the application designating information.

As shown in FIG. 7, for example, the application programs to be activated in the digital television receiver 12 of the embodiment include HTML software, BML software, program recording reservation software, program list generating software, image quality/audio parameter adjusting software, and the like. The numbers corresponding to these application programs are 1, 2, 3, 4, and 5, respectively. With respect to the meta-information, the security is enhanced by using a method of performing SSL (Secure Socket Layer) communication, a method of encoding the contents of the transmitted file, or other methods.

As described above, in the embodiment, the meta-information utilizing numeric characters can designate the applications to be activated in the digital television receiver 12. Accordingly, the server can activate the application on the receiver or can send data to the application on the receiver, so that the control of the receiver can be performed.

As shown in FIG. 8, the portal site server 2 in the embodiment transmits link destination information indicating the link destination, content designating information for designating content data, and the like, in addition to the application designating information.

For example, the link destination information is an URL indicating the location of a predetermined page on the Internet, information indicating the address of a content server connected to the network 15, and the like. The link destination information is processed by an application which is activated based on the application designating information, such as the HTML browser and the BML browser. For example, the content designating information includes the time and date of the start of the broadcast program, the duration, the network ID, a transport stream ID, a service ID, an event ID, and the like. The digital television receiver 12 generates a reservation table of broadcast programs, and the like, based on the content designating information.

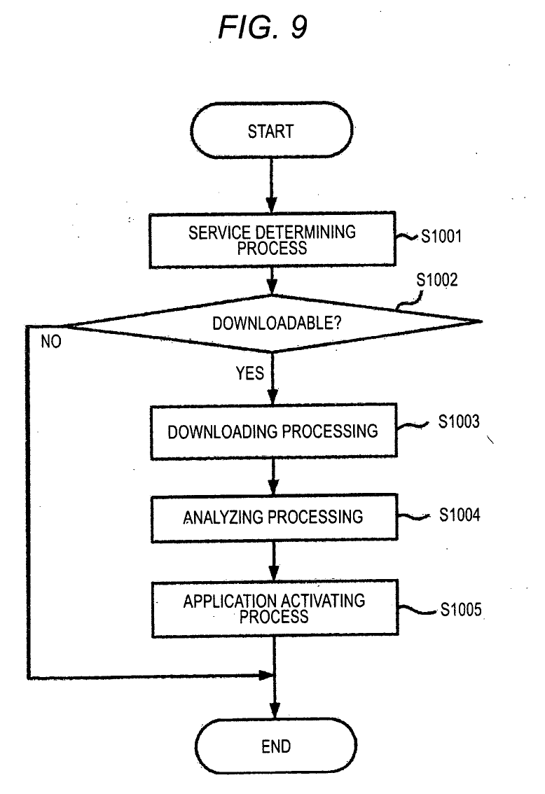

Next, the flow of the processing of the service processing information in the digital television receiver 12 of the embodiment will be described with reference to FIG. 9. FIG. 9 is a flowchart showing the flow of the processing of the service processing information in the digital television receiver 12 of the embodiment.

First, in the case where the service to be provided is determined by designating one of the icons 501 to 506 displayed on the portal screen 500 (S1001), the controller 27 of the digital television receiver 12 determines whether the service corresponding to the icon can be downloaded or not (S1002). If the service cannot be downloaded (No in S1002), the controller 27 terminates the processing. In the digital television receiver 12 of the embodiment, for example, the determination whether the service can be downloaded or not is performed by checking the MIME-TYPE, the extension of the file, or the like.

If the service can be downloaded (Yes in S1002), the service designating information is transmitted to the portal site server 2, and the download processing of the service is started (s1013).

Finally, the digital television receiver 12 analyzes the downloaded information (S1004), activates the designated application, and executes the data processing by the application (S1005).

As described above, according to the embodiment, the convenience of the user related to the data processing can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital television receiver comprising:
a tuner configured to receive a broadcast signal;
a video processor configured to decode video data contained in the broadcast signal and output video signal for displaying the video data;
a communication module configured to establish a connection through a network to a first server providing first content data in a first format and a second server providing second content data in a second format;
an image processing module configured to generate a first link image for connecting to the first server by the communication module and a second link image for connecting to the second server by the communication module; and
a controller configured to control the video processor to output the video signal for displaying the first link image and the second link image.

2. The receiver of claim 1, wherein the communication module is further configured to establish the connection to a third server providing support information,
wherein the image processing module is further configured to generate a support image for displaying the support information, and
wherein the controller is further configured to control the video processor to output the video signal for displaying the first link image and the second link image with the support image.

3. The receiver of claim 2, wherein the image processing module is further configured to generate a third link image for connecting to the third server, and
wherein the controller is further configured to control the video processor to output the video signal for displaying the first link image and the second link image with the third link image.

4. The receiver of claim 2, wherein the support information is HTML format data, and
wherein one of the first content data and the second content data is BML format data.

5. The receiver of claim 2, wherein the support information is BML format data, and
wherein one of the first content data and the second content data is HTML format data.

6. The receiver of claim 2, wherein the controller is further configured to analyze control information obtained from the third server by the communication module and runs a program specified by the control information.

7. The receiver of claim 6, wherein the control information includes a browser designating information for activating one of an HTML browser and a BML browser.

8. The receiver of claim 6, wherein the control information includes a parameter designating information for configuring at least one of an image quality parameter and an audio parameter.

9. The receiver of claim 1 further comprising a display device configured to display a video image in accordance with the video signal output from the video processor.

10. An information processing apparatus comprising:
a communication module configured to establish a connection through a network to a first server providing first content data in a first format, a second server providing second content data in a second format, and a third server providing support information;
an image processing module configured to generate a first link image for connecting to the first server by the communication module, a second link image for connecting to the second server by the communication module, and a third link image for connecting to the third server; and
a display device configured to display the first link image and the second link image with the third link image.

11. An information processing apparatus comprising:
a communication module configured to establish a connection through a network to a first server providing first content data in a first format, a second server providing second content data in a second format, and a third server providing support information;
an image processing module configured to generate a first link image for connecting to the first server by the communication module, a second link image for connecting to the second server by the communication module, and a support image for displaying the support information; and
a display device configured to display the first link image and the second link image with the support image.
